(19) United States
(12) Patent Application Publication
(10) Pub. No.: US 2008/0211422 A1
(43) Pub. Date: Sep. 4, 2008

(54) Halogen Lamp

(75) Inventors: Etienne Eberson, Shanghai (CN); Lei Jiang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/912,344

(22) PCT Filed: Apr. 25, 2006
(86) PCT No.: PCT/IB2006/051274

§ 371 Date: Oct. 23, 2007

(30) Foreign Application Priority Data
Apr. 28, 2005 (CN) 200520016389.5

(51) Int. Cl. H05B 41/24

(52) U.S. Cl. 315/252; 315/315

(57) ABSTRACT

The present invention discloses a halogen lamp, which comprises at least two burners, and a mains-toggle control means for controlling said at least two burners to operate alternatively, in order to achieve different illuminating effects, e.g. to achieve different illuminating angles or different illuminating brightness modes, etc.

### FIELD OF THE INVENTION

The present invention relates to a halogen lamp, in particular, to a halogen lamp capable of realizing multiple lighting modes.

### BACKGROUND OF THE INVENTION

Halogen lamps have been utilized widely in various fields increasingly. Compared to the incandescent lamp, halogen lamp is characterized in that some haloid elements, such as iodine and bromine, are added into the burners and glass shell of the lamp. The uniqueness thereof is in that the tungsten filaments for lighting can realize “self-regeneration”, which prolongs the life span of the burners greatly. Therefore, the burner of halogen lamp can be made small relatively, and thus the bulk of the lamp is small either. Halogen lamps are generally used in the places where concentration of illuminating is needed, for example, lighting for tables or local lighting in the living room.

With the wide application of halogen lamp, it has been attempted to integrate various possible components (such as, lamp holder, reflector and electronic circuit etc.) with halogen lamp into a whole system, so halogen lamp with multiple usage, or working in multiple modes could be realized.

A method called mains-toggle is implemented for communication between the end-user and the lamp. As an example for the Duo-light lamp, a short interruption of the mains switch causes the two burners of the lamp to work alternately, and causes the lamp to switch from full light mode of one of the burners to LED mode of the other burner (lower light output mode).

### OBJECT AND SUMMARY OF THE INVENTION

In accordance with the invention, it is provided a halogen lamp, comprising at least two burners, and a mains-toggle control means for controlling said at least two burners to be operated alternatively, in order to achieve different illuminating effects, such as different illuminating angles or different luminance, etc.

According to an aspect of the invention, it is provided a halogen lamp, comprising at least two burners; a mains-toggle control means for controlling said at least two burners to be operated alternatively, in order to achieve different illuminating effects.

Preferably, said mains-toggle control means includes a stable controller.

Preferably, said stable controller is a bi-stable flip-flop.

Preferably, said mains-toggle control means further includes: a mains interruption detector for detecting interruption of the mains, and outputting a control signal to said stable controller.

Preferably, the interruption time of the mains voltage detected by said mains interruption detector is 1 to 4 seconds.

Preferably, said mains-toggle control means further includes: a AC/DC converter for converting the AC mains voltage to a DC voltage; and a converter for converting the DC voltage to the AC voltage required by said burners.

Preferably, said converter is the one selected from the group consisting of flyback converter, pull-push converter and half-bridge converter.

Preferably, said AC/DC converter is diode rectifying bridge.

Preferably, said converter outputs a 12 volts high-frequency voltage.

Preferably, said halogen lamp further comprises a reflection cap.

The invention itself, together with further objects and advantages, could be apparent by reference to the following detailed description and the accompanying drawings.

### BRIEF DESCRIPTION OF THE DRAWINGS

FIG. 1 shows an embodiment of a halogen lamp in accordance with the present invention;

FIG. 2 is a schematic view shows a mains-toggle control means applied in the halogen lamp in accordance with the present invention.

### DETAILED DESCRIPTION OF THE INVENTION

The present invention provides a halogen lamp capable of realizing multiple illuminating effects, such as multiple different illuminating angles or different luminance, etc. Said halogen lamp comprises at least two burners and a mains-toggle control means for controlling said at least two burners to be operated alternatively, in order to achieve above multiple illuminating effects.

With two burners as an example, the principle of present invention will be explained in the following. It is noted that present invention will be not limited to the case of two burners, and it will be apparent for those skilled in the art to control a plurality of burners to be operated alternatively.

When the lamp is turned on for the first time, the first burner is powered. A short interruption of the mains by means of the mains-switch or circuit breaker, for a period of 1 to 4 seconds for example, will switch over the mains-toggle control means to operate the second burner. When the mains-switch is interrupted for a period of 1-4 seconds again, the mains-toggle control means will switch the power supply of second burner off and then power first burner again.

As above, such multiple stable operations of lamps will provide such an application to the end-user that the end user could select one of the multiple operation modes of lamps as needed, in order to achieve different illuminating effects, such as wide angle illumination or narrow angle illumination, high luminance lighting or low luminance lighting, etc.

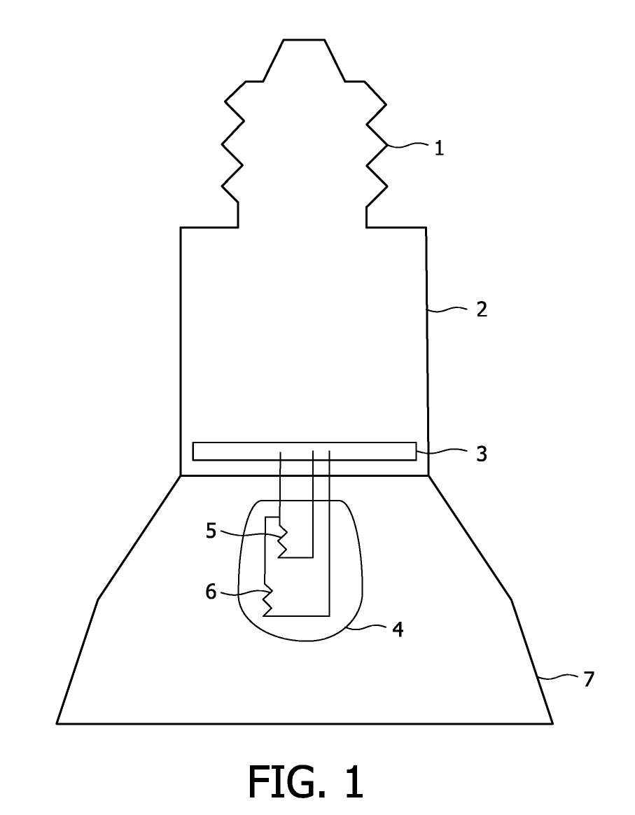

FIG. 1 shows an embodiment of a halogen lamp in accordance with the present invention. The halogen lamp comprises cap 1, shell 2, electronic circuit board 3, bulb 4 and reflector 7. The bulb 4 comprises first burner 5 and second burner 6. Said electronic circuit board 3 contains a mains-toggle control means for operating the two burners to work alternately. When either of the first burner 5 and second burner 6 is working, the light emitted by the burner with a structure of the reflector will cause the lamp to emit wide angle light or narrow angle light, in such a way that the end-user can control the switching of operation of the halogen lamp between two different modes.

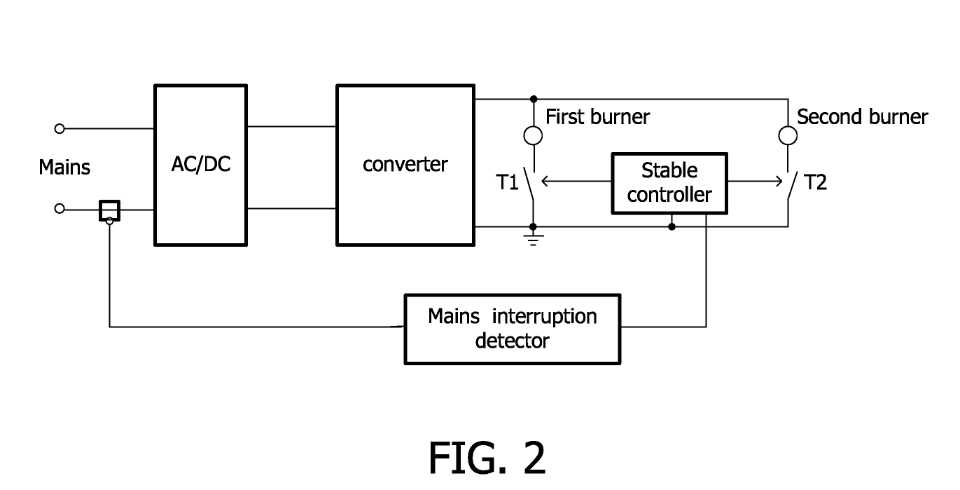

FIG. 2 is a schematic view shows a mains-toggle control means applied in the halogen lamp in accordance with the present invention. Here as an example, a case of two burners operating alternatively will be described.

As shown in FIG. 2, in the mains-toggle control means, mains voltage is connected to an AC/DC converter module, which could be implemented with the well-known diode rectifying bridge in the art, and which functions to rectify the mains voltage to a DC voltage. The output DC voltage is used to power the converter connected to it. This converter is used to convert the DC voltage to an AC voltage needed by the burners, and it could be implemented with the well-known flyback converter, pull-push converter or half-bridge converter.

The converter is input with rectified DC voltage, and outputs a possible 12 Volt high frequency voltage. This high frequency voltage is supplied to the electrodes of first burner and second burner respectively, so as to power them.

The interruption of the mains voltage is detected by means of a mains interruption detector. The information on the interruption of the mains voltage, such as a interruption of 1 to 4 seconds, will be used as an input to the mains interruption detector. The information output by the mains interruption detector will be the input to a stable controller in such a way that each interruption of the mains can toggle the output of the stable controller, in order to trigger the switch T1 and T2 alternatively. In this manner, the first burner and second burner are repetitively switched on and off in an opposite state. Here, the stable controller could be implemented with the well-known bi-stable flip-flop.

In this embodiment, as an example, the period of the interruption of mains voltage can be 1 to 4 seconds. However, this period can be set by the end-user arbitrarily.

A longer interruption of the mains voltage will cause the system to go back in its initial state. This initial state can be the operation mode of the first burner, or the operation mode of the second burner, depending on the system design.

Although the present invention has been described and illustrated with reference to the preferred embodiment, the various changes and modifications will be apparent to those skilled in the arts, and also fall into the scope of the present invention being limited only by the terms of the appended claims. For example, more than two burners could be used; the mains-toggle control means could be located inside the lamp to form an integrated halogen lamp, or located outside the lamp as conventional halogen lamp, or separated from the body of the lamp; Other switching circuits or the like which can implement the function of selecting one from multiple modes could be used, and so on. It is to be clearly understood that the specification is by way of illustration and example only and is not to be taken by way of limitation.

1. A halogen lamp, said halogen lamp comprising:
at least two burners;
a mains-toggle control means for controlling said at least two burners to operate alternatively, in order to achieve different illuminating effects.

2. A halogen lamp as claimed in claim 1, wherein said mains-toggle control means includes a stable controller.

3. A halogen lamp as claimed in claim 2, wherein said stable controller is a bi-stable flip-flop.

4. A halogen lamp as claimed in claim 2, wherein said mains-toggle control means further includes:
a mains interruption detector for detecting interruption of the mains, and outputting a control signal to said stable controller.

5. A halogen lamp as claimed in claim 4, wherein the interruption time of the mains voltage detected by said mains interruption detector is 1 to 4 seconds.

6. A halogen lamp as claimed in claim 4, wherein said mains-toggle control means further includes:
a AC/DC converter for converting the AC mains voltage to a DC voltage; and
a converter for converting the DC voltage to the AC voltage required by said burners.

7. A halogen lamp as claimed in claim 6, wherein said converter is the one selected from the group consisting of flyback converter, pull-push converter and half-bridge converter.

8. A halogen lamp as claimed in claim 6, wherein said AC/DC converter is diode rectifying bridge.

9. A halogen lamp as claimed in claim 6, wherein said converter outputs a 12 volts high-frequency voltage.

10. A halogen lamp as claimed in claim 1, further comprising a reflection cap.
